(19) United States
(12) Patent Application Publication
(10) Pub. No.: US 2020/0012924 A1
(43) Pub. Date: Jan. 9, 2020

(54) PIPELINING TO IMPROVE NEURAL NETWORK INFERENCE ACCURACY

(71) Applicant: SanDisk Technologies LLC, Addison, TX (US)

(72) Inventors: Wen Ma, Sunnyvale, CA (US); Minghai Qin, Milpitas, CA (US); Won Ho Choi, San Jose, CA (US); Pi-Feng Chiu, Milpitas, CA (US); Martin Van Lueker-Boden, Fremont, CA (US)

(21) Appl. No.: 16/180,462

(22) Filed: Nov. 5, 2018

Related U.S. Application Data
(60) Provisional application No. 62/693,615, filed on Jul. 3, 2018.

(51) Int. Cl. G06N 3/063; G06N 5/04; G06N 99/00

(52) U.S. Cl. CPC G06N 3/063; G06N 99/005; G06N 5/046

(57) ABSTRACT

Enhanced techniques and circuitry are presented herein for artificial neural networks. These artificial neural networks are formed from artificial neurons, which in the implementations herein comprise a memory array having non-volatile memory elements. Neural connections among the artificial neurons are formed by interconnect circuitry coupled to input control lines and output control lines of the memory array to subdivide the memory array into a plurality of layers of the artificial neural network. Control circuitry is configured to transmit a plurality of iterations of an input value on input control lines of a first layer of the artificial neural network for inference operations by at least one or more additional layers. The control circuitry is also configured to apply an averaging function across output values successively presented on output control lines of a last layer of the artificial neural network from each iteration of the input value.

### RELATED APPLICATIONS

This application hereby claims the benefit of and priority to U.S. Provisional Patent Application 62/693,615, titled “USE OF PIPELINING TO IMPROVE NEURAL NETWORK INFERENCE ACCURACY,” filed Jul. 3, 2018, which is hereby incorporated by reference in its entirety.

### TECHNICAL FIELD

Aspects of the disclosure are related to the field of artificial neuron circuitry in artificial neural networks.

### BACKGROUND

Artificial neural networks (ANN) can be formed from individual artificial neurons that are emulated using software, integrated hardware, or other discrete elements. Neuromorphic computing can employ ANNs, which focuses on using electronic components such as analog/digital circuits in integrated systems to mimic the human brain, and to attempt a greater understanding of the neuro-biological architecture of the neural system. Neuromorphic computing emphasizes implementing models of neural systems to understand how the morphology of individual neurons, synapses, circuits, and architectures lead to desirable computations. Such bio-inspired computing offers enormous potential for very low power consumption and high parallelism.

Many neuromorphic computing projects that have been carried on including BrainScaleS, SpiNNaker, and the IBM TrueNorth which use semiconductor based random-access memory to emulate the behavior of biological neurons. More recently, emerging non-volatile memory devices, including phase change memory, resistive memory, and magnetic random-access memory, have been proposed to be used to emulate biological neurons as well. Resistive memory technologies in particular have become possible using new materials which have alterable resistance or conductance properties that persist after application of an electric voltage or current.

Unfortunately, various noise effects can occur during neural network operations for neuromorphic computing systems that employ non-volatile memory devices to emulate biological neurons. These noise effects can be significant when designing hardware components for machine learning, among other ANN applications. Also, these sources of noise can have detrimental effects on ANN inference and training operations.

### OVERVIEW

Enhanced techniques and circuitry are presented herein for artificial neural networks. These artificial neural networks are formed from artificial neurons, which in the implementations herein comprise a memory array having non-volatile memory elements. Neural connections among the artificial neurons are formed by interconnect circuitry coupled to control lines of the memory array to subdivide the memory array into a plurality of layers of the artificial neural network. Control circuitry is configured to transmit a plurality of iterations of an input value on input control lines of a first layer of the artificial neural network for inference operations by at least one or more additional layers. The control circuitry is also configured to apply an averaging function across output values successively presented on output control lines of a last layer of the artificial neural network from each iteration of the input value.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an artificial neural network system in an implementation.

FIG. 2 illustrates an operation of an artificial neural network system in an implementation.

FIG. 3 illustrates an artificial neural network system in an implementation.

FIG. 4 illustrates an artificial neural network system in an implementation.

FIG. 5 illustrates an operation of an artificial neural network system in an implementation.

FIG. 6 illustrates performance of an artificial neural network system in an implementation.

FIG. 7 illustrates a computing system to host or control an artificial neural network according to an implementation.

### DETAILED DESCRIPTION

Artificial neural networks (ANN) have been developed to process sets of complex data using techniques deemed similar to biological neurons. Biological neurons characteristically produce an output in response to various synaptic inputs to the neuron cell body, and some forms of artificial neurons attempt to emulate this behavior. Complex networks of artificial neurons can thus be formed, using artificial neural connections among artificial neurons as well as properties of these artificial neurons to process large sets of data or perform tasks too complex for conventional data processors, such as machine learning.

ANNs can be formed from individual artificial neurons that are emulated using software, or from integrated hardware and discrete circuit elements. As discussed herein, artificial neurons can comprise individual memory elements, such as non-volatile memory elements, or might be represented using other types of memory elements or software elements. Artificial neurons are interconnected using artificial neural connections, which are referred to herein as neural connections for clarity. These neural connections are designed to emulate biological neural synapses and axons which interconnect biological neurons. These neural connections can comprise electrical interconnects, such as wires, traces, circuitry, and various discrete or integrated logic or optical interconnects. When memory elements are employed to form artificial neurons, then these neural connections can be formed in part by control lines of any associated memory array. These control lines can include input control lines that introduce data to artificial neurons, and output control lines which receive data from artificial neurons. In specific implementations, the control lines may comprise word lines and bit lines of a memory array.

Various types of ANNs have been developed, which typically relate to topologies for connecting artificial neurons as well as how data is processed or propagated through an ANN. For example, feedforward ANNs propagate data through sequential layers of artificial neurons in a ‘forward’ manner, which excludes reverse propagation and loops. Fully-connected ANNs have layers of artificial neurons, and each artificial neuron is each connected to all artificial neurons of a subsequent layer. Convolutional neural networks (CNNs) are formed by multiple layers of artificial neurons which are fully connected and propagate data in a feed-forward manner.

The process of propagating and processing data through an ANN to produce a result is typically referred to as inference. However, many ANNs must first be trained before data sets can be processed through the ANN. This training process can establish connectivity among individual artificial neurons as well as data processing properties of each artificial neuron. The data processing properties of artificial neurons can be referred to as weights or synaptic weights. Synaptic weights indicate a strength or amplitude of a connection among two artificial neurons. This can correspond to an amount of influence that firing a first artificial neuron has on another artificial neuron.

Various implementations have been developed to form ANNs that execute machine learning tasks, among other data processing tasks within an ANN framework. For example, a conventional central processing unit (CPU) can typically process very complex instructions efficiently but can be limited in the amount of parallelism achieved. However, in machine learning computation, especially training tasks, the basic operation is vector matrix multiplication, which is a simple task performed an enormous amount of times. A graphics processing unit (GPU), which has started to gain favor over CPUs, uses a parallel architecture and can handle many sets of very simple instructions. Another emerging implementation uses an application specific integrated circuits (ASIC), which can implement a tensor processing unit (TPU) that is efficient at executing one specific task. As machine learning becomes more integrated into more applications; interest has grown into making special purpose circuitry that can efficiently handle machine learning tasks.

Another concern for implementing machine learning is electrical power consumption. A machine learning task can take GPUs or TPUs up to hundreds of watts to execute. In contrast, the human brain can execute similar cognitive tasks by using only around 20 watts. Such power-hungry disadvantages have inspired the study of biologically-inspired or brain-inspired approaches, such as neuromorphic computing, to deal with machine learning limitations.

Neuromorphic computing can employ ANNs, and focuses on using electronic components such as analog/digital circuits in very-large-scale-integration (VLSI) systems to attempt to mimic the human brain, especially in trying to understand and learn from the neuro-biological architecture of the neural system. Neuromorphic computing emphasizes on implementing models of neural systems and understand how the morphology of individual neurons, synapses, circuits, and architecture lead to desirable computations. Such biologically inspired computing offers enormous potential for very low power consumption and high parallelism. Related research has been done to study the spiking neural networks, and synaptic learning rules such as spike-timing dependent plasticity. Many neuromorphic computing projects that have been carried on for several years including BrainScaleS, SpiNNaker, and the IBM TrueNorth which use SRAM or SDRAM to hold synaptic weights.

More recently, emerging non-volatile memory devices, including phase change memory (PCM), resistive random-access memory (RRAM or ReRAM), and magnetic random-access memory (MRAM) formed from magnetic tunnel junctions (MTJs), have been proposed to be used to emulate synaptic weights as well. These devices fall into the broad category of memristor technology and can offer very high density and connectivity due to a correspondingly small footprint. Resistive memory technologies, such as those in the aforementioned memristor category, have become possible using new materials which have alterable resistance states or conductance states that persist after application of an electric voltage or current. Memristors and other related resistive memory devices typically comprise electrical components which relate electric charge to magnetic flux linkage, where an electrical resistance of a memristor depends upon a previous electrical current or voltage passed by the memristor.

Non-volatile memory (NVM) elements representing synaptic weights of artificial neural networks will be considered below, although the enhanced circuitry and techniques can be applied across other circuit types and ANN topologies. Individual NVM elements can be formed into large arrays interconnected via control lines coupled to the NVM elements. In some examples, these control lines can include bit line and word line arrangements, but the control lines, in other embodiments, can include other elements and interfaces with other memory array arrangements. In the examples herein, non-volatile memory (NVM) arrays are employed to implement various types of ANNs. Specifically, resistive memory elements are organized into addressable arrays of artificial neurons used to form an ANN. Control line connections, can be used to not only write and read the NVM elements in an array, but also to logically subdivide the NVM array into logical sub-units of an ANN, referred to as layers. These layers may each comprise an arbitrary quantity of NVM elements, which typically are determined by a desired quantity of artificial neurons, or nodes, for each layer. Typically, the arbitrary quantity of NVM elements is the same in each layer, but other embodiments may use different numbers of NVM elements in each layer. In some examples, nodes of each layer can comprise entire memory pages of an NVM array, or might span multiple memory pages. Furthermore, nodes of a layer might instead only employ a subset of the NVM elements for particular memory pages, and thus a single memory page might be shared among layers. In further examples, the NVM elements might not employ traditional memory page organization, and instead comprise a ‘flat’ array of column/row addressable elements.

As mentioned above, artificial neural networks can be formed using large collections of artificial neurons organized into distinct layers of artificial neurons. These layers can be combined into an arrangement called a deep neural network, among other arrangements. Deep neural networks typically include an input layer, and output layer, and one or more intermediate layers between the input and output layers. These intermediate layers are referred to as hidden layers. Deep neural networks are popular in machine learning, especially for image classification, object detection or speech recognition applications. Deep neural networks are one of the most widely used deep learning techniques. Deep feedforward neural networks like convolutional neural networks (CNNs) or multi-layer perceptions (MLPs) are suitable for processing static patterns such as images. Recurrent deep neural networks like long short-term memory (LSTM) are good at processing temporal data like speech.

Various noise effects can occur during deep neural network training and inference for neuromorphic computing, as well as for other ANN operations. These noise effects can be significant when designing hardware components for machine learning. Two types of noise include forward propagation noise and weight update noise, and will be discussed in more detail below. However, these sources of noise can have detrimental effects on inference operations and may also be detrimental to training operations in some instances. In the enhanced circuitry and techniques presented herein, a pipelining approach can reduce at least forward propagation noise in artificial neural networks. Advantageously, these enhanced pipelined ANNs can increase classification accuracies of inference operations, and potentially approach ideal levels comparable to the Modified National Institute of Standards and Technology database (MNIST) test performed when no noise is present.

Sources of noise in various circuitry, such as forward propagation noise and weight update noise, is now discussed. The basic training operations of a deep feedforward neural network, such as a multi-layer perceptron, can be classified into several categories: forward propagation, computing cost, backward propagation, and parameter updates. The basic inference operations include: forward propagation, feeding a resultant log it vector into a “softmax” layer, and determining a prediction as a result with the highest probability. A softmax layer is employed in artificial neural networks to present a result that is normalized over a target numerical range. For example, a probability can be presented from values of 0 to 1, and a softmax layer can interpret output values from an artificial neural network and normalize these output values over the scale of 0 to 1. Other scales and normalization functions can be applied in a softmax layer.

One source of noise is weight update noise. This source of noise can come from artificial neurons that store synaptic weights in an NVM array. These artificial neurons can be formed by memory devices that have variation effects when synaptic weight updates are made. During training, the synaptic weights are updated during each training epoch. During inference, the synaptic weights are updated only once when we program previously trained synaptic weights from software or a storage device into the initial array. Mitigation solutions to weight update noise are beyond the scope of this discussion.

Another source of noise is forward propagation noise. Forward propagation noise can arise at the circuit and device level, which might affect both the training and inference stages of operating artificial neural networks. Specifically, in a deep neural network with several fully connected layers, forward propagation is conducted in every layer by calculating a vector matrix multiplication of values input to a layer. The input values can comprise an input image or activations from previous layer, and stored weights. In the NVM array examples herein, input values are represented by voltages fed into input control lines comprising word lines of the NVM array, and stored weights are represented by present conductance values or conductance states of NVM elements in the NVM array. An NVM array utilized in this manner can be referred to as a weight memory array. The vector matrix multiplication result of each layer is then read out from associated output control lines comprising output control lines of the NVM array in the form of electrical current values, Forward propagation noise might arise from analog-to-digital converter (ADC) processes, among other sources. In the ANNs discussed herein, ADCs can connect to electrical current outputs from output control lines and convert the analog electrical current outputs to digital representations for transfer to digital peripheral circuits.

Forward propagation noise comprises signal noise that arises during forward propagation operations, which is typically of the Gaussian noise type, among others. This noise can include analog and digital noise introduced by various circuit elements of an ANN, such as layer interconnect circuitry, ADC circuit elements, and other circuit elements. Forward propagation noise can be mathematically represented at the input of the activation function: Wx+b, also called the pre-activation parameter. W is the weight matrix, x is the activations from a previous layer (or input data of a first layer), and b is the bias vector. Without the noise, the activation function of the linear part of a layer forward propagation should be:

ƒ(Wx+b)

After adding the forward propagation noise, the activation function becomes:

ƒ(Wx+b+Z),Z˜N(0,σ²), where σ=β(Wx+b)

β is the forward propagation noise in percentage.

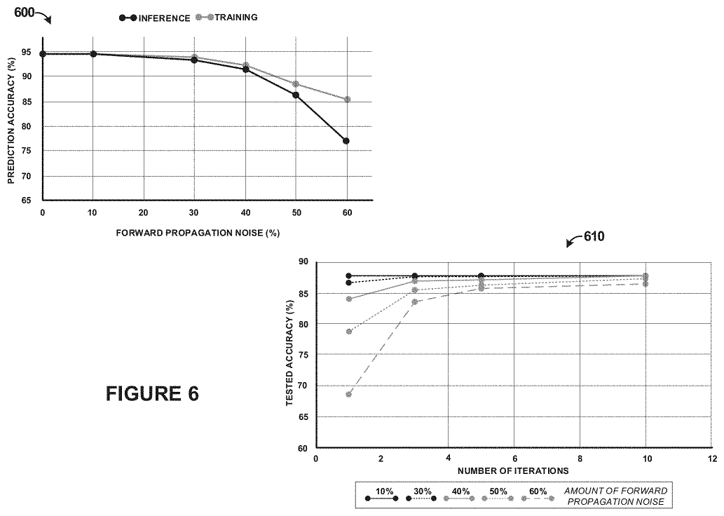

The effect of forward propagation noise on training and inference can be seen in graph 600 of FIG. 6, Prediction accuracy using test data comprising the MNIST handwritten digit database is tested when different levels of forward propagation noise is added either during the training stage or during the inference stage. As graph 600 shows, as forward propagation noise (horizontal axis) increases, prediction accuracy (vertical axis) quickly decreases. Thus, a reduction in forward propagation noise desired for ANNs. Graph 600 predicts that the forward propagation noise effect on training operations is smaller than on inference operations. During the training operations, the error from a last layer iteration will get compensated at a current layer iteration. For inference operations, a final log it vector comprising non-normalized predictions is obtained in a last layer before being fed into a softmax function to generate normalized probabilities for classification. This final log it vector will have errors due to the accumulation of forward propagation noise from previous layers. And these errors will cause the classification accuracy to drop, as seen in graph 600.

In some instances, forward propagation noise can be reduced by modifying an associated neural network training method. However, in the examples herein, neural network training is not modified, and an enhanced pipelining technique on inference is employed. This example pipelining can improve inference accuracy by reducing forward propagation noise within deep neural networks. As the domain of artificial intelligence is an emerging application for non-volatile memory (NVM), these pipelining examples herein can improve performance of an associated neural network. Pipelining can also reduce total run time, as discussed below.

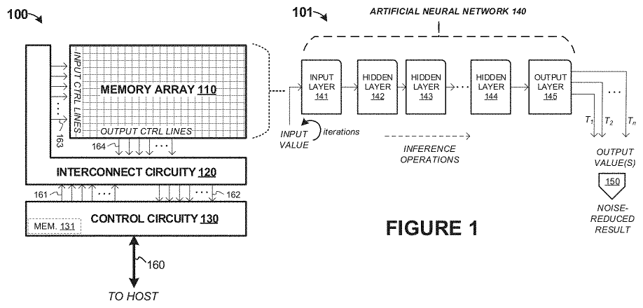

Turning now to circuit structures that can be used to implement enhanced artificial neural networks, FIG. 1 is presented. FIG. 1 illustrates schematic view 100 with memory array 110 employed as an NVM array-based synaptic weight array, along with peripheral circuitry to realize one or more layers in a deep neural network. Peripheral circuitry can include interconnect circuit 120 and control circuitry 130, which comprise example circuitry to at least interconnect and operate a synaptic weight array for one or more layers in a deep neural network. In one example, a single layer of the ANN might comprise a fully connected network formed from two layers and having a weight array size of 784×10. This example weight array size corresponds to 784 rows for input neurons and 10 columns for output neurons.

Also shown in FIG. 1 are input control lines 163 and output control lines 164, which comprise control lines for accessing memory array 110. Input control lines 163 are employed to introduce data to each layer of the ANN formed by the artificial neurons of memory array 110. Output control lines 164 are employed to read out resultant data from each layer of the ANN. Interconnect circuitry 120 comprises various interconnection circuitry comprising line drivers, lines, switches, sense amplifiers, analog or digital accumulators, analog-to-digital conversion circuitry, or other circuitry used to drive input control lines 163 and monitor/read values presented on output control lines 164. Interconnection circuitry among interconnect circuitry 120 includes electrical connections made among control lines of memory array 110 to create one or more ANN layers among corresponding NVM elements, among other configurations. These control lines are employed by interconnect circuitry 120 to access the individual NVM elements, which might be further organized into memory pages and the like. In some examples, interconnection among layers of the ANN can be formed using logical or physical connections established by interconnect circuitry 120. In other examples, this interconnection can instead occur in control circuitry 130. In specific examples, the input control lines might comprise word lines of an NVM array, and the output control lines might comprise bit lines of an NVM array. However, control lines 163-164 can correspond to other arrangements when different memory technologies are employed or different physical arrangements than row/column configurations. For example, control lines might couple to individual memory cells when non-arrayed configurations of artificial neurons are employed, or when discrete memory cells are employed.

Control circuitry 130 comprises various circuitry and processing elements used for introduction of input data to memory array 110 and interpretation of output data presented by memory array 110. The circuitry and processing elements can include activation functions, softmax processing elements, log it vector averaging circuitry, forward propagation noise reduction function circuitry, and storage circuitry. Control circuitry 130 can provide instructions, commands, or data over control lines 161 to interconnect circuitry 120. Control circuitry 130 can receive resultant data determined by memory array 110 over lines 162. Interconnect circuitry 120 can apply any adjustments or signal interpretations to the signaling presented by output control lines 164 before transfer to control circuitry 130. Output data can be transmitted to one or more external systems, such as a host system, over link 160. Moreover, input data can originate over link 160 from one or more external systems before training or inference by the ANN.

Control circuitry can also include one or more memory elements or storage elements, indicated in FIG. 1 by memory 131. Memory 131 might comprise volatile or non-volatile memory devices or memory spaces. In one example, memory 131 is employed as an output buffer to store synaptic weights for artificial neurons of an ANN. Control system 130 can load these synaptic weights into NVM elements of memory array 110 prior to introduction of input data to the ANN layers. Memory 131 can also be configured to store input data and output data. This output data might comprise individual log it vectors produced by an output layer of the ANN before introduction to a softmax process. Moreover, memory 131 can store output probabilities after log it vectors have been normalized by a softmax process. In the examples below, an ANN pipelining technique is discussed, and memory 131 can store intermediate and final values for an ANN pipeline.

Memory array 110 comprises an array of memory devices, specifically non-volatile memory devices. In this example, these NVM devices comprise memristor-class memory devices, such as memristors, ReRAM, MRAM, PCM, or other device technologies. The memory devices may be connected into an array of columns and rows of memory devices accessible using selected word lines and bit lines. However, other memory cell arrangements might be employed and accessed using input control lines 163 and output control lines 164. Memory array 110 can be used to implement a single layer of an artificial neural network, or instead might implement a multi-layer ANN. Each layer of an ANN is comprised of a plurality of nodes or artificial neurons. Each artificial neuron corresponds to at least one NVM element in memory array 110. In operation, individual NVM elements in memory array 110 store synaptic weights, loaded from memory 131 by control circuitry 130, with values established at least by training operations.

FIG. 1 also includes an example multi-layer ANN 140 formed within memory array 110, as shown in configuration 101. Each layer of ANN 140 is comprised of a plurality of nodes or artificial neurons. Each artificial neuron corresponds to at least one NVM element in memory array 110. ANN 140 includes an input layer 141, one or more hidden layers 142-144, and an output layer 145. Input values are presented to input layer 141 for propagation and processing through one or more hidden layers 142-144, and final presentation as output values by output layer 145. The propagation and processing operations can be referred to as inference operations, which typically occur after a training process establishes synaptic weights to be stored by artificial neurons of each layer.

Layers, as used herein, refers to any collection or set of nodes which share a similar data propagation phase or stage in an ANN interconnection scheme. For example, nodes of a layer typically share similar connection properties with regard to preceding layers and subsequent layers. However, layering in an ANN, in certain embodiments, may be a logical organization of nodes of the ANN which layers can differ depending upon the ANN topology, size, and implementation. Input layers comprise a first layer of an artificial neural network which receives input data, input values, or input vectors for introduction to the ANN. Typically, an input layer will have a quantity of input nodes which correspond to a size or length of an input value/vector. These input nodes will then be connected to a subsequent layer according to a connection style, such as fully connected or partially connected, and the like. Layers that lie in between an input layer and an output layer are referred to as intermediate layers or ‘hidden’ layers. Hidden layers and hidden nodes are referred to as ‘hidden’ because they are hidden, or not directly accessible for input or output, from external systems. Various interconnection styles can be employed for nodes in hidden layers as well, such as fully connected or partially connected. Finally, an output layer comprises a final layer, or last layer, of nodes of the ANN which receives values from a last hidden layer or a last intermediate layer and presents these values as outputs from the ANN. The quantity of nodes in the output layer typically correspond to a size or length of an output value. These output values are commonly referred to as log its or log it vectors, and relate to a prediction made by the ANN after inference processes have propagated through the various hidden layers. The log it vectors can be further processed in an additional layer, referred to commonly as a softmax layer, which scales the log it vectors according to a predetermined output scale, such as a probability scale from 0 to 1, among others.

In one example operation, ANN 140 can be operated in a non-pipelined manner. In this non-pipelined example, a single instance of input data is introduced at input layer 141 and propagates through hidden layers before an output value is presented at output layer 145. Output layer 145 can pass this output value to an optional softmax process or softmax layer which normalizes the output value before transfer to an external system as a prediction result. The total time to propagate this single instance of input data through ANN 140 takes ‘m’ time steps, one for each layer of ANN 140. However, propagating a single instance of the input through ANN 140 might lead to an increased influence of forward propagation noise in the output value from each layer of ANN 140.

ANN 140 can also be operated in an enhanced pipelined manner. Configuration 101 illustrates a pipelined operation of ANN 140. In configuration 101, several layers have been established which comprise one or more artificial neurons. These layers can include input layer 141, one or more hidden layers 142-144, and output layer 145. The interconnection among these layers can vary according to implementation, and the pipelining techniques can apply across various amounts of layer interconnection.

In the pipelined operation, a particular input value can be propagated through the layers of ANN 140 as part of an inference operation. However, more than one instance of this input value can be iteratively introduced to input layer 141. Specifically, control circuitry 130 presents an input value more than one time to input layer 141. ANN 140 produces an output value for each instance or iteration of the input value propagated through ANN 140. As shown in configuration 101, output values T₁, T₂, and Tₙ can result from the same input value introduced to ANN 140 a target quantity of times. However, output values T₁, T₂, and Tₙ will typically vary even though output values T₁, T₂, and Tₙ result from the same input value. This variation is due in part to forward propagation noise which can arise in circuitry between layers of ANN 140.

Although each output value might be employed by control system 130 or one or more external systems, in this example noise reduction function 150 is employed. Noise reduction function 150 stores or buffers each output value produced from a particular input value, which might span several instances or iterations of the same input data. After a target quantity of iterations completes, then noise reduction function 150 executes a noise reduction process to reduce at least the forward propagation noise in the output values. Noise reduction function 150 thus produces a noise-reduced result for ANN 140.

As used herein, noise reduction function refers to a style, form, or type of digital, optical, or analog electrical signal noise reducing process, function, or feature, and associated circuits, circuit elements, software elements, and the like that perform the noise reduction function. In one example, a noise reduction function comprises an averaging function applied across more than one output value or more than one set of output values. In certain example noise reduction functions, various weightings or scaling among the output values might be applied to give preference to one or more of the output values over time. Other noise reduction functions can include, but are not limited to, various noise filters, ‘companding’ (compression/expansion) functions, noise limiter functions, linear or non-linear filters, smoothing filters, high-pass or low-pass filters, Gaussian filtering, smoothing filters, wavelet filters, statistical filters, machine-learning based filtering function, or anisotropic diffusion, among others.

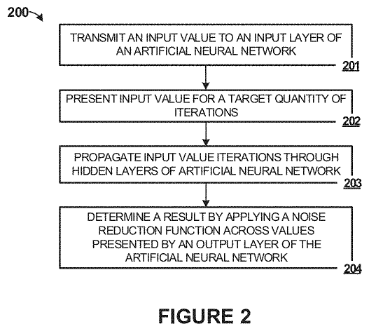

Turning now to an addition discussion on the operation of elements of FIG. 1, FIG. 2 is presented. FIG. 2 is flow diagram 200 illustrating a method of operating an artificial neural network. In FIG. 2, operations are related to elements of FIG. 1. However, the operations of FIG. 2 can apply to any of the implementations discussed herein, among others.

In operation, control circuitry 130 transmits (201) an input value to input layer 141 of artificial neural network (ANN) 140. The input value might comprise a digital representation of image data or a portion of image data, among other data to be processed by ANN 140. This input value can be processed by ANN 140 according to the synaptic weights and neural connections that form the various layers of ANN 140 in a process called inference. To initiate this inference process, control circuitry 130 transfers the input value over links 161 for presentation to artificial neurons comprising input layer 141 formed in memory array 140. Interconnect circuitry 120 presents the input value as a vector of input voltages over at least a portion of input control lines 163 that correspond to NVM elements in input layer 141. The input voltages can vary depending upon the requirements of the memory array technology, but typically comprise a binary representation of the input value.

Control circuitry 130 and interconnect continues to present (202) the input value for a target quantity of iterations. Each iteration comprises a period of time for the input data to propagate through input layer 141 to a subsequent layer of ANN 140, such as hidden layer 142 in FIG. 1. Thus, ANN 140 will be presented with the same input value for a predetermined quantity of instances in a serial fashion. The quantity of instances can vary based on application, based on a desired amount of noise reduction in a result, or based on anticipated noise levels of the various layers of ANN 140. A further discussion of selection of the quantity of instances of an input value will be presented below.

ANN 140 propagates (203) successive input value iterations through hidden layers of ANN 140. As seen in FIG. 1, at least one hidden layer is included in ANN 140 between input layer 141 and output layer 145. Input layer 141 operates on the input value and passes an intermediate result from input layer 141 to a first hidden layer, such as hidden layer 142. If more than one hidden layer is included, then each hidden layer operates on an intermediate result from a previous layer and propagates a further intermediate result to another subsequent layer. Once output layer 145 is reached in the propagation process, then output layer 145 can present an output value that results from operation and propagation through ANN 140 for a particular instance of an input value.

However, the simplified view of ANN 140 in configuration 101 of FIG. 1 is a logical illustration of the operation of ANN 140. In schematic view 100, a particular implementation might vary from that shown in configuration 101. Specifically, each layer is formed by a collection of artificial neurons comprising NVM memory elements. Each layer will have a corresponding set of input control lines and output control lines for accessing NVM memory, elements of the layer. Input values or intermediate values are presented on input control lines of each layer, and intermediate results or output values are presented on output control lines of each layer. Interconnect circuitry 120 and control circuitry 130 operate to present values to each layer on layer-specific input control lines among input control lines 163, and receive values from each layer on layer-specific output control lines among output control lines 164. The structure seen in configuration 101 can thus be built using individual sets of NVM elements and associated control lines.

Each individual layer will process a layer-specific input value introduced on associated input control lines to produce a layer-specific result on associated output control lines. The layer-specific result will depend in part on the connectivity among layers, established by interconnection configurations in interconnect circuitry 120 and control circuitry 130. The layer-specific result will also depend in part on the synaptic weights stored in the individual NVM elements. The synaptic weights for each layer are programmed by control circuitry 130, such as from synaptic weights stored in memory 131. When resistive memory elements are employed, the synaptic weights can be stored as conductance values or conductance states, which comprises the memory values stored in each NVM memory element. Each NVM element might have a plurality of input connections from a preceding layer, which are represented by input voltages on corresponding input control lines. Forward propagation operations in each layer are thus conducted by calculating a vector matrix multiplication of input voltages on corresponding input control lines for each NVM element and stored synaptic weights. This vector matrix multiplication result is presented on output control lines of the layer as analog electrical ent values.

Circuit elements in interconnect circuitry 120 and control circuitry 130 convert received output control line currents in an analog format into digital representations. First, output control lines can be coupled to sense amplifier circuitry to convert the electrical currents into voltage representations. Then, analog-to-digital converter (ADC) circuitry can convert the electrical voltage representations into digital representations. Various operations can be performed on these digital representations, such as when the present digital representations comprise output values for ANN 140 from output layer 145. Also, various activation functions might be applied. If the digital representations correspond to an intermediate layer, such as a hidden layer, then the digital representations might be presented onto input control lines of a subsequent layer for propagation operations by that subsequent layer. Noise can be introduced by any of the circuit elements involved in the layer interconnection and intermediate value sensing/conversion processes discussed above. This noise comprises forward propagation noise, and can reduce an accuracy in a final result produced by ANN 140.

To reduce the influence of forward propagation noise, the pipelined approach shown in configuration 101 is employed. This pipelined approach produces several output values (T₁, T₂, . . . Tₙ), which can all vary due to variations in forward propagation noise encountered by each successive instance of an input value. Control circuit 130 receives these output values and determines (204) a result by applying noise reduction function 150 across values presented by output layer 145 of ANN 140. This result comprises a noise-reduced result, which applies a noise reduction function over output values T₁, T₂, . . . Tₙ. In some examples, the noise reduction function comprises an averaging function applied over all output values resultant from a particular input value. However, the noise reduction function might be another function that assigns weights or confidence levels among different instances of output values according to various factors, such as estimated noise for each instance, level of interconnect employed among the layers, number of layer neurons for each layer, anticipated noise levels in ADC circuitry, or other factors, including combinations thereof.

This noise-reduced result can then be transferred for use in various applications. For example, when image data is used as the input value, then this result might be used in machine learning applications, image processing or image recognition applications, or other applications. Moreover, the result might be a partial result which is combined with other results from other input values pipelined through ANN 140.

In further operations, control circuit 130 can select a target quantity of propagations through the artificial neural network for each instance of input data or input values. For example, control circuit 130 can be configured to select a target quantity of propagations for an averaging function to bring a forward propagation noise of the artificial neural network to below a threshold level. Control circuit 130 can be configured to select a quantity of the successive instances to reduce the forward propagation noise and reach at least a target inference accuracy in the result, or select the target quantity of iterations to reduce forward propagation noise of the artificial neural network and reach a target inference accuracy in the result. Example target inference accuracy which relates to a target quantity of successive instances of an input value can be seen in graph 601 of FIG. 6, and will be discussed in more detail below.

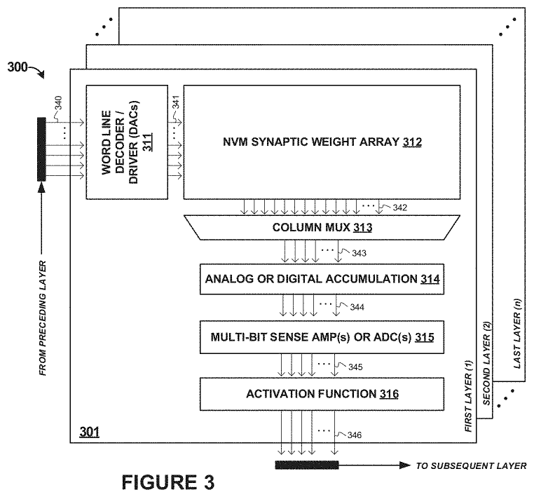

Turning now to another implementation of an artificial neural network, FIG. 3 is presented. FIG. 3, example sources of forward propagation noise are discussed in the context of ANN architecture 300. ANN architecture 300 employs NVM memory elements organized into an array. This array employs a row and column arrangement which is accessible over input control lines and output control lines. In this example, the input control lines comprise word lines 341 and the output control lines comprise bit lines 342. Although other configurations of control lines are possible, for the purposes of this example a word/bit line arrangement will be discussed.

As discussed herein, artificial neural networks can be implemented in hardware. This hardware can generate noise from associated circuits or devices used to implement the artificial neural network. In an artificial neural network with several fully connected layers, forward propagation is conducted in every layer by calculating a vector matrix multiplication of stored weights and input values, where the input values are either from an input value presented to an input layer or intermediate activations from a previous layer.

Forward propagation can take the mathematical form of calculating f(w*X+b), where f: an activation function comprising terms of X: input, w: synaptic weights, and b: biases. The input values are usually represented by voltages fed into word lines of a layer, and stored weights are represented by conductance states or conductance values in a weight memory array. A weight memory array might comprise an array of NVM devices, such as memristors, coupled via associated word lines and bit lines. The vector matrix multiplication is read out from the bit lines in the form of current values. The forward propagation noise can be introduced by at least analog-to-digital converters (ADCs) which connect a present layer output from bit lines to digital peripheral circuits, among other circuit elements. Distorted results can appear after the aforementioned vector matrix multiplication due in part to this circuit and device noise introduced during forward pass. This forward propagation noise can harm inference accuracy of the ANN.

Turning now to a discussion on the elements of FIG. 3, architecture 300 includes a plurality of layers (1) through (n) which form an artificial neural network. Interconnections among the layers can be made by various peripheral circuitry which is not shown in FIG. 3 for clarity. This interconnection includes coupling to layer input lines 340 and layer output lines 346. Corresponding input and output lines are found on each layer. The layers, when coupled together, can form an artificial neural network like that seen in configuration 101 of FIG. 1, although variations are possible.

Elements of an individual exemplary layer are shown in FIG. 3. Specifically, layer 301 includes word line decoder and driver digital to analog converters (DACs) 311, non-volatile memory (NVM) synaptic weight array 312, column multiplexer (MUX) 313, analog or digital accumulation circuit 314, multi-bit sense amplifiers or analog-to-digital converters (ADCs) 315, and activation function 316. Intra-layer interconnect links 341-345 are shown in FIG. 3, which can vary according to implementation in quantity and signal configuration.

Word line decoder and driver digital to analog converters (DACs) 311 receive input data over links 340 from a preceding layer of an ANN, or from a control system when used on an input layer. When received in an analog format, then DACs can be included to convert this analog format into a digital voltage used to drive word lines 341. Word line decoder elements can be included to drive specific word lines associated with the present layer. When a large memory array, such as an NVM array, is employed, then many layers might share the same NVM array. Subsets of the memory elements of the NVM array can correspond to individual layers, and thus word line decoders can use an address or control signal to only drive input values onto corresponding word lines of the particular layer.

Non-volatile memory (NVM) synaptic weight array 312 comprises an array of memory elements, such as resistive memory elements, memristors, MRAM elements, PCM elements, or others. Moreover, memory elements of NVM synaptic weight array 312 are configured to store values corresponding to synaptic weights of particular layers of an ANN. These values can be pre-loaded before inference operations by a control system. The synaptic weights can be determined during a training process for the associated ANN initiated by a control system, or might established by software models or algorithmic processes. Each layer can have a corresponding set of synaptic weights. Synaptic weight refers to a strength or amplitude of connection between two artificial neurons, also referred to as nodes. Synaptic weight corresponds to the amount of influence that a biological neuron has on the firing of another.

Column multiplexer (mux) 313 is employed in read operations to select bit lines of NVM synaptic weight array 312 for each layer. Column mux 313 can select among bit lines 342 to present values read from selected bit lines on links 343. Analog or digital accumulation circuit 314 receives read values on links 343 from column mux 313 and can buffer or store values temporarily before conversion into a digital format by multi-bit sense amplifiers or analog-to-digital converters (ADCs) 315. When sense amplifiers are employed, the sense amplifiers can sense read values presented on the bit lines and condition or convert these read values received over links 344 into logic levels, perform current-to-voltage conversion processes, or condition read values, among other operations. ADCs can convert analog representations of the read values into digital representations which represent the read values, such as those read values converted by sense amplifier portions. ADCs can output the digital representations over links 345 for input to one or more activation functions 316 or for input to one or more subsequent layers when activation functions 316 are not employed.

Typically, an activation function provides a behavioral definition for an artificial neuron, referred to as a node. The digital representations received over links 345 can be used as inputs to the activation function which define an output of each artificial neuron. As the activation function can define behavior among artificial neurons in response to inputs, any result from the activation function is considered an output of the artificial neuron. The outputs of the activation function are then used to drive another layer of artificial neurons over links 346. When the activation function is on a last layer or output layer, then the output of the activation function can be considered an output of the ANN.

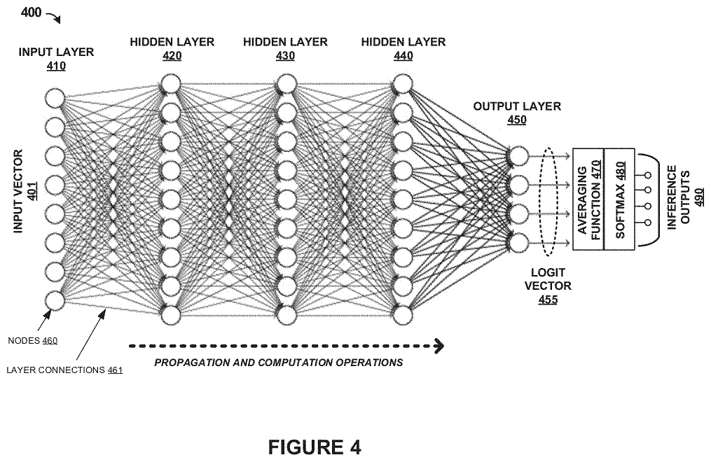

In operation, layers of an ANN will be interconnected according to layer connections, and data will propagate through the ANN and be altered according to synaptic weights and activation functions of each layer and associated nodes. Layers of FIG. 3 can be interconnected according to the example shown in FIG. 4, although other configurations are possible.

FIG. 4 illustrates an example process for a fully-connected feedforward neural network is presented. In a feedforward neural network, information moves in only one direction (forward) beginning at the input nodes, propagating through any hidden nodes according to weights and biases of each interconnection/node, and finally is presented at the output nodes as a result. Also, cycles or loops are not employed in a feedforward neural network. The fully connected property of this feedforward neural network indicates that each preceding node is fully connected to all subsequent nodes, although other configuration are possible. Each node can represent a neuron, and might comprise an NVM element as discussed herein, such as memristor elements.

Specifically, FIG. 4 illustrates node connections in example artificial neural network 400. ANN 400 includes input layer 410, hidden layers 420, 430, and 440, and output layer 450. Input vector 401 is transmitted to input layer 410 for propagation and computation through ANN 400. Output layer 450 presents output log it vector 455. Log it vector 455 comprises uncompensated output values after propagation and computation of input vector 401 through ANN 400. Log it vector 455 might be employed in further external systems without further processing. However, in many implementations a further processing layer is added, referred to as a softmax layer. Softmax layer 480 can scale log it vector 455 across a desired output scale, such as a probability scale from 0 to 1, among others. Also, in the examples herein, averaging function 470 can be employed, and will be discussed below.

As mentioned herein, nodes each comprise an artificial neuron, and are represented by nodes 460 in FIG. 4. Artificial neural network 400 comprises a fully-connected artificial neural network, where each node in a present layer is connected to every node in a preceding layer and to every node in a subsequent layer via layer connections 461. Synaptic weight values for each node indicate how much strength (or ‘weight’) input connections for a node shall receive relative to each other. Stronger weight values indicate that a connection receives a larger consideration in the node, and weaker weight values indicate that a connection receives a smaller consideration in the node. Thus, each node can have a spectrum of strength among connections to nodes in adjacent layers, such as stronger connections and weaker connections. An activation function associated with each node then instructs each node how to respond to the input values that have been weighted according to the corresponding synaptic weights. Each node then presents an output onto connections to a subsequent layer. Input nodes are special in that input nodes receive input data for the ANN, and do not receive output data on connections from a preceding layer. Likewise, output nodes present an output from the ANN, and do not present this output data on connections to subsequent layers.

When used in pipelining techniques described herein, the same input vector 401 might be presented to ANN 400 for more than one iteration. As outputs log it vectors 455 are generated by ANN 400 on output layer 450, averaging function 470 can buffer each log it vector 455 over the course of the iterations of the same input vector. Once the predetermined quantity of iterations completes propagation and computation through ANN 400, then a noise reduced result can be presented to softmax layer 480. In FIG. 4, the noise reduced result is computed as an average across all log it vectors 455 for a particular input vector.

Before inference operations by ANN 400, indicated by propagation and computation operations in FIG. 4, training of ANN 400 must first occur. Training of an artificial neural network includes determining parameters for each of the nodes (weights, biases) to minimize cost (prediction error, loss). Training operations of a feedforward neural network can include operations of forward propagation, cost computing, backward propagation, parameters update. Inference operations then comprise making a prediction using the artificial neural network based on trained parameters (weights, biases). Inference operations include forward propagation, then feeding output log its into a “softmax” layer, indicating a prediction. The examples herein focus on forward propagation noise from the circuit and device level, which can affect both the training and inference stages.

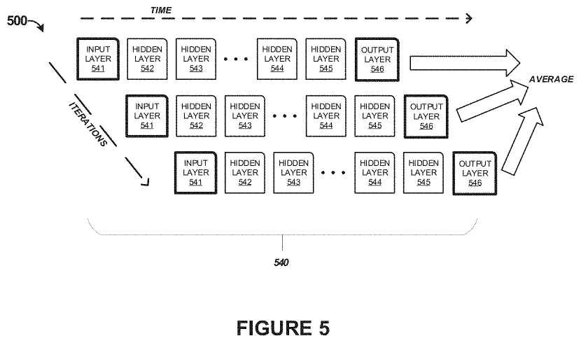

FIG. 5 illustrates the pipelining techniques for an artificial neural network, according to an implementation. In FIG. 5, exploded pipeline configuration 500 is shown as comprising timewise instances of execution through an artificial neural network, such as ANN 540. Similar techniques can be applied to any of the ANNs discussed herein.

In FIG. 5, input data, which might comprise an input image, is first presented to input layer 541 for propagation through ANN 540 during inference operation. The same input image is presented to input layer 541 for a predetermined quantity of instances, which is three instances in this example. Inference operations occur as the data propagates through hidden layers 542-545 and finally output layer 546. Three instances of output values are produced by ANN 540 as log it vectors, and these three log it vectors are averaged to produce a result. This result is determined before any softmax function or softmax layer is applied. This result also corresponds to a noise reduced result, typically having lower forward propagation noise than any of the individual log it vectors.

During inference, the examples herein run a deep neural network for ‘k’ (for k>1) times for each input image, and log it vector noise is averaged out over ‘k’ outputs before feeding it into a final softmax layer to get a final prediction probability. Specifically, an average is taken of the log it vectors at the output layer (before a final softmax layer) to get a final prediction probability. Thus, each image input can be run for ‘k’ times instead of just 1 time to increase accuracy in final prediction probability.

To reduce total run time, a pipelining approach is presented in FIG. 5. Suppose there are ‘n’ hidden layers in a neural network, then n+1 time steps are needed to finish one run for one input image data. To reduce a total run time to run each input image for times with the pipelining approach, the pipelining approach starts executing the (m−1)^{th} layer of the (r+1)^{th} run while running the m^{th} layer of the r^{th} run. Under this pipelining scenario, the artificial neural network only needs n+k time steps to run an input image on the artificial neural network with ‘n’ hidden layers for ‘k’ times. Without enhanced pipelining, an artificial neural network would need (n+2)*k time steps to run an input image. Advantageously, with the enhanced pipelining, the neural network needs n+k+1 time steps to run an input image to produce a noise reduced result.

Continuing with the discussion regarding pipelining in an artificial neural network, this enhanced pipelining technique differs from other computing pipelining techniques. Data is introduced to the artificial neural network pipeline via an input layer. A predetermined number ‘n’ of internal hidden layers is used within the neural network pipeline, followed by an output layer. The number of hidden layers ‘n’ can be selected based on the application, implementation, complexity, and depth of the neural network, and can vary from the number of layers shown in FIG. 5. As the input data, such as an input image, propagates through each hidden layer of the artificial neural network pipeline, that same data continues to be re-introduced to the input layer. This same data continues to be introduced to the input layer of the pipeline for a selected run time.

A selected run time or run period is used for applying the same input data to the neural network pipeline to reduce forward propagation noise. In the examples herein, the quantity is used to generalize the number of sequential inputs or ‘runs’ of the same input data to the artificial neural network pipeline. The number ‘k’ can be selected based on a desired accuracy or based on expected forward propagation noise levels.

Graph 610 of FIG. 6 illustrates example runs using various values for ‘k’, where accuracy generally improves for increasing ‘k’ values. However, additional runs can correspond to additional total run time. Thus, a desired accuracy level can be selected, and the number of runs ‘k’ can be selected to produce this accuracy level. Graph 610 indicates improvement of MNIST classification accuracy by using the pipelining approach under different levels of forward propagation noise. Prediction accuracy is tested when different levels of forward propagation noise is added during the inference stage, and when each input image is run for different times. In graph 610, example results are shown with different percentages of test noise are injected forward propagation noise. As can be seen, various levels of forward propagation noise can be reduced by using the pipelining approach, with a larger number of runs corresponding to more accurate results in all cases.

This specific test scenario of graph 610 is run on a one layer fully connected neural network for MNIST classification. The neural network is run ‘k’ times to take the average of log it vector before the softmax layer. By using only one run per image, severe inference accuracy degradation can be seen at large noise, indicated by the first data point in the plot of graph 610. By using more runs per image with the pipelining approach, accuracy can be improved as seen. After using the pipelining approach by running each input image for ‘k’ (k>1) times, classification accuracy improves quickly when ‘k’ (number of runs) increases.

As mentioned above for graph 600, test predictions can be conducted using different levels of Gaussian noise that is added during forward propagation at inference. The weights are trained offline and have been programmed into the memory array before running the inference. Graph 600 shows a decreasing trend in classification accuracy with increasing noise level. In graph 600, the number of inference runs for a particular input value is fixed at 1. However, graph 601 illustrates results from using the pipelining approach discussed herein. After using the pipelining approach by running each input image for k (k>1) times, classification accuracy improves quickly when k (number of runs) increases. Graph 601 indicates that k=5 is sufficient to bring the accuracy up to a desired value, although a greater number of runs can be used for greater accuracy.

By using the pipelining approach, each instance of image data is run on the network for ‘k’ (k>1) times, and the noise effect can be statistically minimized by averaging results from the ‘k’ runs. This pipelining approach can increase the classification accuracy while keeping the inference run time relatively short. As a further example of pipelining, inference processes run a deep neural network for ‘k’ (k>1) times for each input image to average out the noisy log it vectors before feeding it into a final softmax layer to get the final prediction probability.

For example, when ‘k’ is selected as 6, then six cycles of data introduction occur for the same input data to the input layer. Four (4) hidden layers might be employed in this example as a value for ‘n’. The same input data is introduced on successive cycles of the neural network pipeline, namely six times in this example. As the data propagates through the four hidden layers of the neural network pipeline, eventually six different output values are obtained at an output layer. This timeframe is approximately 6±4=10 cycles or time steps (i.e. ˜k+n).

The six different output values can vary among each other, even though same input data is introduced to the neural network pipeline. This variation can be due to forward propagation noise inherent in the neural network, among other noise sources. The output values are buffered or otherwise held until 10 cycles are completed through the neural network pipeline. Once all 10 cycles have been completed, then the six different output values are averaged together to form a result. This result comprises an average output value from the six output values, which arise from the same input data introduced into the neural network pipeline.

Thus, instead of transmitting the individual output values as independent results, as done in many computing pipelines, the neural network pipeline discussed herein combines many output values over a selected ‘k’ number of runs, such as the six output values mentioned above. An averaging function or other mathematical function can be applied across all of the output values for the same input data to establish a result. Forward propagation noise is advantageously, reduced in the result.

Many modern machine learning hardware applications focus on inference, or edge machines, and many networks are trained offline in GPUs or TPUs. Advantageously, the examples herein can use pipelining to tolerate forward propagation noise during inference. During inference, the examples herein run a deep neural network for k>1) times for each input image to average out the noisy log it vectors before feeding it into the final softmax layer to get the final prediction probability. To reduce total run time, a pipelining approach is presented. Suppose we have ‘n’ hidden layers in our deep neural network, and we need n+1 time steps to finish one run for one input image. So to save the total run time to run each input image for ‘k’ times with the pipelining approach, we start executing the (m−1)^{th} layer of the (r+1)^{th} run while running the m^{th} layer of the r^{th} run, Under this pipelining scenario, we only need n+k time steps to run an input image on a deep neural network with ‘n’ hidden layers for ‘k’ times.

As discussed herein, implementing machine learning in hardware can expect many noise sources coming from the circuits or the devices. The examples herein can relate to the forward propagation noise that can be caused by periphery circuitry. For training of neural networks, weight update noise can be tolerated better than the forward propagation noise. Both noise types can harm the training performance to some significant extent. Inference comprises using a trained neural network to determine predictions based on input data. The pipelined approach is presented herein to address and forward propagation noise issue for at least inference operations.

The examples herein discuss various example structures, arrangements, configurations, and operations for enhanced artificial neural networks and associated artificial neuron circuits. One example arrangement comprises using pipelining to reduce forward propagation noise. During inference operations, a pipelined neural network is run for times for each input image to average out forward propagation noise before feeding it into a final layer to get a final prediction probability. Specifically, an average is taken of log it vectors presented at an output layer of the neural network to get a final prediction probability with reduced forward propagation noise.

Another example arrangement comprises using a pipelined neural network to increase result generation speeds. Without enhanced pipelining, a fully-connected neural network with ‘n’ hidden layers might need (n+2)*k time steps to run, where the neural network is run for ‘k’ times for each input image. Advantageously, with the enhanced pipelining, the neural network needs only about (n+k) time steps to run. Thus, the pipelined neural networks herein are run for multiple times for one input image, and pipelining is used to reduce the total run time.

In one example implementation, a circuit comprising a feedforward artificial neural network is provided. This feedforward artificial neural network comprises an input layer, output layer, and ‘n’ hidden layers between the input layer and output layer. An input circuit is configured to introduce input data to the input layer for propagation through at least the ‘n’ hidden layers. An output circuit configured to calculate an average of ‘k’ log it vectors presented at the output layer for the input data to produce a result. The input circuit can be further configured to introduce the input data to the input layer ‘k’ number of iterations, where each iteration of the ‘k’ number of iterations comprises waiting until a previous introduction of the input data has propagated through at least one of the ‘n’ hidden layers. Moreover a method of operating the example circuit can be provided. The method includes running the feedforward artificial neural network for the ‘k’ number of iterations with the input data, and averaging the ‘k’ log it vectors presented at the output layer resultant from the input data to reduce forward propagation noise associated with processing the input data with the feedforward artificial neural network.

In another example implementation, a circuit comprising a feedforward artificial neural network comprises an input layer, an output layer, and one or more hidden layers between the input layer and output layer. An input control circuit is configured to introduce iterations of an input value to the input layer for propagation through at least the one or more hidden layers. An output control circuit configured to calculate an average of output values presented at the output layer from the iterations of the input value to produce a result. The circuit comprising the input control circuit can be configured to introduce the input value to the input layer a target quantity of iterations, where each iteration of the target quantity of iterations comprises waiting until a previous introduction of the input value has propagated through at least one hidden layer.

The example circuit can further comprise a memory element coupled to the output layer that is configured to store at least the output values from the target quantity of iterations for calculation of the average. The circuit comprising the input control circuit configured to select the target quantity of iterations to reduce forward propagation noise in the result to reach a target inference accuracy in the result.

In yet another example implementation, an artificial neural network is presented. This artificial neural network comprises a means for pipelining a target quantity of instances of a same input value through at least a hidden layer of the artificial neural network, a means for producing a series of output values resultant from the target quantity of instances of the same input value propagating through at least the hidden layer, and a means for applying a propagation noise reduction function across the series of output values to determine a result. The artificial neural network can also comprise means for selecting the target quantity to mitigate forward propagation noise of the artificial neural network and reach a target inference accuracy in the result. The propagation noise reduction function might comprise an averaging function.

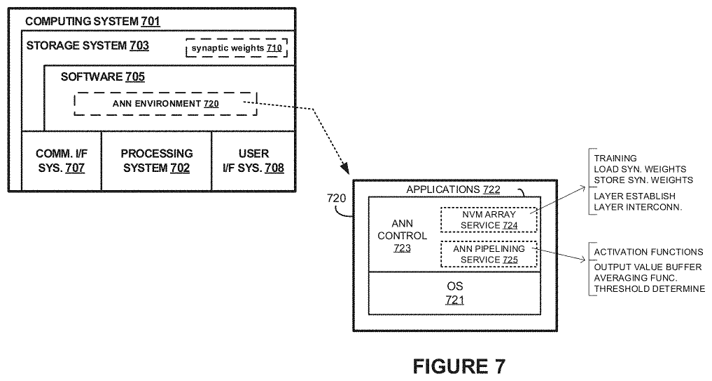

FIG. 7 illustrates computing system 701 that is representative of any system or collection of systems in which the various operational architectures, scenarios, and processes disclosed herein may be implemented. For example, computing system 701 can be used to implement control system 130, interconnect circuitry 120, or host system of FIG. 1, averaging function 470 or softmax layer 480 of FIG. 4, or any other instance of control circuitry or noise reduction functions discussed herein. Moreover, computing system 701 can be used to store and load synaptic weights into NVM arrays, configure interconnect circuitry to establish one or more layers of an artificial neural network, and determine synaptic weights through training operations. In yet further examples, computing system 701 can fully implement an artificial neural network, such as that illustrated in FIG. 4 or 5, to create an at least partially software-implemented artificial neural network with reduced noise behavior. Computing system 701 can implement any of the pipelined operations discussed herein, whether implemented using hardware or software components, or any combination thereof.

Examples of computing system 701 include, but are not limited to, computers, smartphones, tablet computing devices, laptops, desktop computers, hybrid computers, rack servers, web servers, cloud computing platforms, cloud computing systems, distributed computing systems, software-defined networking systems, and data center equipment, as well as any other type of physical or virtual machine, and other computing systems and devices, as well as any variation or combination thereof.

Computing system 701 may be implemented as a single apparatus, system, or device or may be implemented in a distributed manner as multiple apparatuses, systems, or devices. Computing system 701 includes, but is not limited to, processing system 702, storage system 703, software 705, communication interface system 707, and user interface system 708. Processing system 702 is operatively coupled with storage system 703, communication interface system 707, and user interface system 708.

Processing system 702 loads and executes software 705 from storage system 703. Software 705 includes artificial neural network (ANN) environment 720, which is representative of the processes discussed with respect to the preceding Figures. When executed by processing system 702 to implement and enhance ANN operations, software 705 directs processing system 702 to operate as described herein for at least the various processes, operational scenarios, and sequences discussed in the foregoing implementations. Computing system 701 may optionally include additional devices, features, or functionality not discussed for purposes of brevity.

Referring still to FIG. 7, processing system 702 may comprise a microprocessor and processing circuitry that retrieves and executes software 705 from storage system 703. Processing system 702 may be implemented within a single processing device, but may also be distributed across multiple processing devices, sub-systems, or specialized circuitry, that cooperate in executing program instructions and in performing the operations discussed herein. Examples of processing system 702 include general purpose central processing units, application specific processors, and logic devices, as well as any other type of processing device, combinations, or variations thereof.

Storage system 703 may comprise any computer readable storage media readable by processing system 702 and capable of storing software 705, and capable of optionally storing synaptic weights 710. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, resistive storage devices, magnetic random access memory devices, phase change memory devices, or any other suitable non-transitory storage media.

In addition to computer readable storage media, in some implementations storage system 703 may also include computer readable communication media over which at least some of software 705 may be communicated internally or externally. Storage system 703 may be implemented as a single storage device, but may also be implemented across multiple storage devices or sub-systems co-located or distributed relative to each other. Storage system 703 may comprise additional elements, such as a controller, capable of communicating with processing system 702 or possibly other systems.

Software 705 may be implemented in program instructions and among other functions may, when executed by processing system 702, direct processing system 702 to operate as described with respect to the various operational scenarios, sequences, and processes illustrated herein. For example, software 705 may include program instructions for enhanced pipelined ANN operations using multiple instances of input data to reduce noise in results of the ANN, among other operations.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software or other application software, in addition to or that include ANN environment 720. Software 705 may also comprise firmware or some other form of machine-readable processing instructions executable by processing system 702.

In general, software 705 may, when loaded into processing system 702 and executed, transform a suitable apparatus, system, or device (of which computing system 701 is representative) overall from a general-purpose computing system into a special-purpose computing system customized to facilitate enhanced pipelined ANN operations using multiple instances of input data to reduce noise in results of the ANN. Indeed, encoding software 705 on storage system 703 may transform the physical structure of storage system 703. The specific transformation of the physical structure may depend on various factors in different implementations of this description. Examples of such factors may include, but are not limited to, the technology used to implement the storage media of storage system 703 and whether the computer-storage media are characterized as primary or secondary storage, as well as other factors.

For example, if the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

ANN environment 720 includes one or more software elements, such as OS 721 and applications 722. These elements can describe various portions of computing system 701 with which elements of artificial neural networks or external systems can interface or interact. For example, OS 721 can provide a software platform on which application 722 is executed and allows for enhanced pipelined ANN operations using multiple instances of input data to reduce noise in results of the ANN.

In one example, NVM array service 724 implements and executes training operations of ANNs to determine synaptic weights for artificial neurons. NVM array service 724 can interface with NVM elements to load and store synaptic weights for use in inference operations. Moreover, NVM array service 724 can establish layers among NVM elements to implement layers and nodes of an ANN, such as by controlling interconnect circuitry. In further examples, NVM array service 724 receives intermediate values from intermediate or hidden layers and provides these intermediate values to subsequent layers.

In another example, ANN pipelining service 725 controls operation of a pipelined ANN as described herein. For example, ANN pipelining service 725 can implement one or more activation functions for layers of an ANN. ANN pipelining service 725 can also buffer output values after inference of individual input values to a pipelined ANN. ANN pipelining, service 725 can apply one or more noise reduction functions, such as averaging functions, to the buffered output values to produce noise-reduced results. ANN pipelining service 725 can implement softmax layers or softmax functions as well. Moreover, ANN pipelining service 725 can determine thresholds for noise levels based on target quantities of iterations for input values introduced to an ANN. ANN pipelining service 725 can also receive input values from one or more external systems for introduction to a pipelined ANN, and provide noise-reduced results to the one or more external systems.

Communication interface system 707 may include communication connections and devices that allow for communication with other computing systems (not shown) over communication networks (not shown). Communication interface system 707 might also communicate with portions of hardware-implemented ANNs, such as with layers of ANNs, NVM-implemented weight arrays, or other ANN circuitry, Examples of connections and devices that together allow for inter-system communication may include NVM memory interfaces, network interface cards, antennas, power amplifiers, RF circuitry, transceivers, and other communication circuitry. The connections and devices may communicate over communication media to exchange communications or data with other computing systems or networks of systems, such as metal, glass, air, or any other suitable communication media.

User interface system 708 is optional and may include a keyboard, a mouse, a voice input device, a touch input device for receiving input from a user. Output devices such as a display, speakers, web interfaces, terminal interfaces, and other types of output devices may also be included in user interface system 708. User interface system 708 can provide output and receive input over a data interface or network interface, such as communication interface system 707. User interface system 708 may also include associated user interface software executable by processing system 702 in support of the various user input and output devices discussed above. Separately or in conjunction with each other and other hardware and software elements, the user interface software and user interface devices may support a graphical user interface, a natural user interface, or any other type of user interface.

Communication between computing system 701 and other computing systems (not shown may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transmission control protocol (TCP), and the user datagram protocol (UDP), as well as any other suitable communication protocol, variation, or combination thereof.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above can be combined in various ways to form multiple embodiments. As a result, the invention is not limited to the specific embodiments described above, but only by the claims and their equivalents.

What is claimed is:

1. A circuit, comprising:
artificial neurons comprising a memory array having non-volatile memory (NVM) elements;
neural connections between the artificial neurons comprising interconnect circuitry coupled to control lines of the memory array to subdivide the memory array into a plurality of layers of an artificial neural network; and
control circuitry coupled to the interconnect circuitry and configured to:
transmit a plurality of iterations of an input value on input control lines of a first layer of the artificial neural network for inference operations by at least one or more additional layers; and
apply an averaging function across output values successively presented on output control lines of a last layer of the artificial neural network from each iteration of the input value.

2. The circuit of claim 1, the control circuitry further configured to:
propagate vectors of analog voltages to the input control lines of the layers for computation by corresponding artificial neurons of the layers; and
detect electrical currents from corresponding output control lines of the layers to produce the vectors of analog voltages for introduction to successive layers.

3. The circuit of claim 2, wherein at least synaptic weights for the artificial neurons are established as conductance states of the NVM elements.

4. The circuit of claim 2, further comprising:
sense amplifiers coupled to the output control lines and configured to convert the electrical currents into digital representations for introduction to activation functions that determine the vectors for the successive layers.

5. The circuit of claim 1, the control circuitry further configured to transmit the input value to achieve a target quantity of propagations through the artificial neural network, wherein each iteration of the target quantity is initiated after a previous introduction of the input value propagates through at least a first layer of the artificial neural network.

6. The circuit of claim 5, comprising:
the control circuitry configured to select the target quantity for the averaging function to bring a forward propagation noise of the artificial neural network to below a threshold level.

7. The circuit of claim 1, further comprising:
a buffer coupled to the control circuitry and configured to store log it vector representations of the plurality of output values for input to the averaging function.

8. The circuit of claim 1, wherein the inference operations comprise computation and forward propagation operations.

9. An artificial neural network, comprising:
an input layer;
an output layer;
one or more intermediate layers between the input layer and the output layer, each comprising one or more nodes having accompanying node connections and synaptic weights;
a control circuit coupled to the input layer and configured to introduce a plurality of successive instances of input data to the input layer for propagation through at least the one or more intermediate layers; and
the control circuit coupled to the output layer and configured to reduce a forward propagation noise in a result based at least on applying a noise reduction function to successive output values presented at the output layer resultant from the plurality of successive instances of the input data.

10. The artificial neural network of claim 9, comprising:
the control circuit configured to introduce the input data to the input layer for a target quantity of iterations of the input data to propagate through the artificial neural network, wherein each iteration of the target quantity of iterations is initiated after a previous introduction of the input data propagates through at least a first intermediate layer.

11. The artificial neural network of claim 9, wherein the noise reduction function comprises an averaging function applied over the successive output values.

12. The artificial neural network of claim 9, further comprising:
an output buffer coupled to the output layer configured to store at least a portion of the successive output values for input to the noise reduction function.

13. The artificial neural network of claim 9, comprising:
the control circuit configured to select a quantity of the successive instances to reduce the forward propagation noise and reach at least a target inference accuracy in the result.

14. The artificial neural network of claim 9, wherein each of the successive output values comprise log it vectors prior to introduction to a softmax process.

15. The artificial neural network of claim 9, wherein the one or more nodes of each of the one or more intermediate layers comprise non-volatile memory elements that store the synaptic weights and yield node outputs based at least in part on conductance values of the non-volatile memory elements, and wherein the node outputs are coupled to analog-to-digital conversion circuitry for introduction to further instances of the one or more intermediate layers according to at least corresponding node connections, wherein at least a portion of the forward propagation noise of the artificial neural network is associated with the analog-to-digital conversion circuitry.

16. A method comprising:
introducing an input value to an input layer of an artificial neural network over a target quantity of iterations for propagation through at least one hidden layer of the artificial neural network; and
determining a result by applying a noise reduction function among log it vectors presented by an output layer of the artificial neural network after the target quantity of iterations of the input value have completed propagation through the at least one hidden layer.

17. The method of claim 16, comprising:
determining the result by applying the noise reduction function based at least on averaging the log it vectors resulting from the target quantity of iterations.

18. The method of claim 16, wherein the result is computed to reduce forward propagation noise associated with processing of the input value through the at least one hidden layer of the artificial neural network.

19. The method of claim 18, further comprising:
selecting the target quantity of iterations to reduce forward propagation noise of the artificial neural network and reach a target inference accuracy in the result.

20. The method of claim 16, further comprising:
in a memory element coupled to the output layer, storing at least the output values from the target quantity of iterations for input to the noise reduction function.
